(19) United States
(12) Patent Application Publication
(10) Pub. No.: US 2004/0133468 A1
(43) Pub. Date: Jul. 8, 2004

(54) Method and system for providing interactive adversing cross reference to related application

(76) Inventor: Kivin G. Varghese, Danville, VA (US)

Correspondence Address: Ian G DiBernardo, Stroock & Stroock & Lavan, 180 Maiden Lane, New York, NY, 10038, US

(21) Appl. No.: 10/474,242

(22) PCT Filed: Apr. 12, 2002
(86) PCT No.: PCT/US02/11449

(51) Int. Cl. G06F 17/60

(52) U.S. Cl. 705/14

(57) ABSTRACT

A method and system of providing interactive advertising via the Internet, print, radio and other mediums. According to one embodiment, the method comprises presenting an advertisement to a user; presenting questions to the user, the questions related to the advertisement; providing an amount of credits to the user, the amount based on a number of the questions answered correctly by the user. Such advertisements may be provided via the Internet, print, radio and other mediums. The credits may take any form, including monetary, coupons, merchandise credits and the like.

### CROSS REFERENCE TO RELATED APPLICATION

The present application claims the benefit of U.S. Provisional Application Serial No. 60/283,471 filed on Apr. 12, 2001, entitled Advertising Delivery System, which is incorporated herein by reference.

### BACKGROUND OF THE INVENTION

1. Field of the Invention

The present invention relates to methods and systems for providing on-line advertising and, more particularly, to providing interactive advertising

2. Description of Related Art

Advertising on the Internet is typically in the form of banner advertisements, which deliver the advertiser's message along the horizontal top edge of a web page and, more recently, in the form of skyscraper advertisements, which deliver the advertiser's message along a vertical edge of a web page. As evidenced by the recent drop in advertising fees, the efficacy of such advertising, however, is suspect. These types of ads are always present and are of very little interest to the user, as they are often very similar and are often static. Furthermore, users have the ability to ignore the advertisements by scrolling through the web page to make all or a portion of the advertisement disappear. As such, these types of advertisements are ineffective, and a need exists for a more effective form of advertising.

More recently, dynamic advertisements, for example, animated multimedia characters, have been used. These types of advertisements, while more noticeable than the typical banner and skyscraper advertisements, are often intrusive, and annoying to users. Moreover, there is no real indication that such dynamic advertisements are effective. Furthermore, although such animated advertisements are often entertaining, they are often ineffective in conveying the advertiser's message. Accordingly, a need still exists for an improved method and system for delivering advertising.

3. Summary of the Invention

These and other needs are satisfied by the method and system of providing interactive advertising of the present invention. According to one embodiment, the method comprises presenting an advertisement to a user; presenting questions to the user, the questions related to the advertisement; providing an amount of credits to the user, the amount based on a number of the questions answered correctly by the user. Such advertisements may be provided via the Internet, print, radio and other mediums. The credits may take any form, including monetary, coupons, merchandise credits and the like.

### BRIEF DESCRIPTION OF THE DRAWINGS

The following figures, which form a part of the present disclosure, are representative of exemplary embodiments of the present invention, and is not intended to be limiting of the scope of the invention which is defined by the claims appended hereto.

FIG. 1 is a schematic illustrating the system according to one embodiment of the present invention;

FIGS. 2-9 are screens of a user interface according to one embodiment of the present invention; and

FIGS. 10-18 are screens of an administrator interface of one embodiment of the present invention.

### DETAILED DESCRIPTION OF EMBODIMENTS

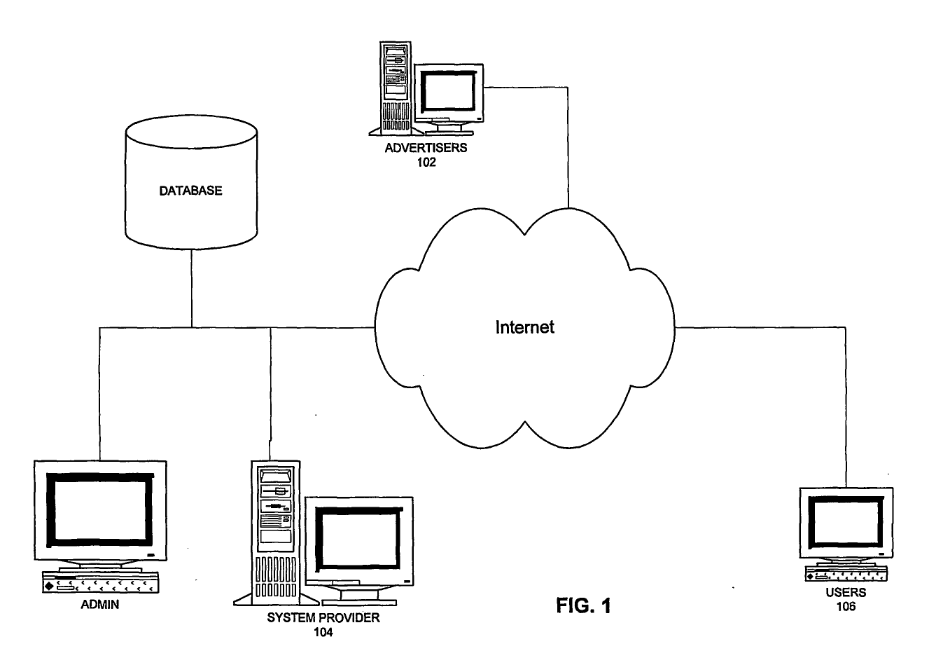

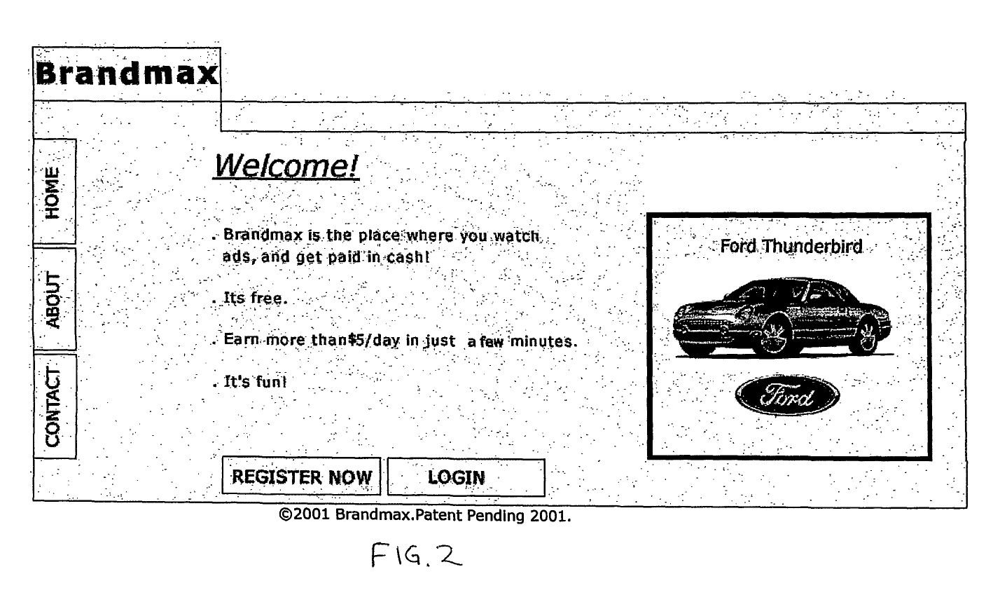

Certain embodiments of the present invention will now be described in greater detail with reference to the aforementioned figures. In general, the embodiment illustrated in FIG. 1 allows advertisers 102 to provide advertisements to a system provider 104, which in turn, provides users 106 with access to such advertisements. As described in greater detail below, the system provider 104 provides an advertising delivery system that solicits feedback from the users 106, thereby allowing for “closed-loop” communication between one or more advertisers 102 and their targeted audience (e.g., certain users 106). In the present embodiment, the interactive nature of the delivery system is in the form of presenting questions to the users 106. The questions are based on advertisements viewed by the users 106 and are directed to ensuring the users 106 receive and understand the advertiser's message. Additionally, in the present embodiment, advertisers 102 provide incentives to the users 106 to understand the advertisement and the message therein by providing credits for answering the questions correctly. Such include monetary payments, merchandise credit, sweepstakes entries, coupons or other promotional vehicles and the like.

As illustrated, the present embodiment involves advertisers 102, which preferably have computer systems, such as one or more servers or personal computers, connected to a network, such as the Internet, for providing information, including the advertisements, to the system provider 104. The system provider 104 also has a computer system, such as one or more servers (for example, a web server, application server and media server), coupled to a database. As described in greater detail below, the database stores the information used in administering the advertising delivery method and system. The system provider 104 provides a website through which the users 106 provide information and access the advertisements. As such, each user 106 preferably includes a computer, such as a personal computer, web-enabled cell phone, personal digital assistant, set-top box or other interactive television system, and the like.

As noted above, the system provider 104 preferably includes a database for storing information utilized in the present embodiment. It is to be understood that such information may be stored in any of a number of ways, including one or more databases having one or more tables. Furthermore, the logical arrangement and relationship of such data and/or tables within a database may take any of a number of forms. As such, the following is one exemplary structure of the database.

The database includes a user authorization table which includes authorization information for each user 106, as identified by a unique user identifier (ID). As such, each record in the table includes the user ID, the user's login ID and password, the user's status (e.g., Enabled (user's demographic and identification data has been entered correctly, e.g., 9 digits entered for Social Security number); Disabled (user's data has not been entered correctly, and needs to be corrected by the user, or user's account has been manually suspended for another reason), Verified (user's demographic and identification data has been validated as accurate and truthful by a third-party verification service like Experian) and Unverified (user has submitted registration information and the information is in the process of being validated for accuracy and truthfulness), an indication of the last Internet protocol address from which the user 106 accessed the system, and the total number of user logins. As with the other tables, each record preferably includes the date and time the record was created, and the date and time the user profile was last modified.

The database also includes a user profile table that includes for each user, as identified by user ID, a user profile containing user identifying information. In the present embodiment, the profile (and thus each record) includes the user's date of birth, gender, marital status, nationality, number of members of the household, including the age of each member, the user's profession, the total household income, the user's race and the state in which the user lives.

Additional user identifying information is contained in a user details table, which for each user ID, contains the user's first, middle and last name, driver's license number, social security number, address, e-mail, phone number(s), credit card information (name, number, expiration date, etc.), user's billing address, bank account information, and the dates the record was created and last modified. In the present embodiment, the credit card information is used primarily to verify the user's identity and, therefore, may be replaced or augmented by driver's license information and the like.

In the present embodiment, the users 106 are provided with cash incentives for correctly answering the advertising questions. While such monetary incentives may be provided to the users 106 in any of a number of ways, for example, by crediting the user's credit card account or bank account or simply issuing a check or other form of payment, the present invention may alternatively use a third party on-line payment service in which users of the service transfer money using the third party service as a conduit. One well-known service provider is PayPal, Inc., whose system is described on the PayPal site at the domain www.paypal.com. In short, such third party systems typically enable any business or consumer with an email address to open an account with the third party and to securely send and receive payments online. The third party creates the user account based on the user's personal data, such as credit card and/or bank information, and by verifying the user's e-mail address. To send money to a recipient, the user access the third party's website and enters information, such as the recipient's name, e-mail address and amount to be sent. The recipient receives the cash in his/her account with the third party, and the amount is billed to the sender's account (which is tied electronically to credit card, debit card or checking account associated with the sender's account). The recipient receives the money based on details and preferences associated with the recipient's account. Accordingly, information necessary for such third party service (such as a separate ID or email address) may also be included in the user details table.

In addition to including information on the individual users 106, the system provider 104 includes information concerning the advertisers 102 and the advertisements being served. For example, the database includes an advertisement header table which stores certain high level information concerning each advertisement. To this end, each record in the advertisement header table includes, for each advertisement as identified by a unique advertisement ID, the name of the advertisement, the date on which the advertisement may begin to be provided to users 106, the date on which the advertisement may no longer be provided to users 106, the name of the advertiser and the brand being marketed in the advertisement.

Additionally, the advertisement header table includes information relating to the incentive being provided. In the present embodiment, as discussed in greater detail below, users 106 are provided with three questions, and are awarded a different dollar amount for answering a different number of questions correctly. As such, the table includes the maximum credit incentive for answering all questions correctly. Additionally, the advertisement header table includes credit and debit information for the advertisement. More specifically, the credit information includes the total amount of credits (in the present embodiment, dollars) that may be awarded to users 106 viewing the advertisement. Similarly, the debit amount associated with the advertisement indicates the amount of credits provided to users 106 in response to correctly answering questions concerning the advertisement. In general, the advertisement may be provided to users 106 so long as enough credits remain.

The advertisement header table also includes a status field for indicating which of the following statuses the advertisement has: Active (advertisement has not yet reached the total incentive credit level, as set in the advertisement header table or the audience level that advertiser has set) and Inactive (advertisement has reached the total incentive credit level or audience level that the advertiser has set, and is no longer available for users 106 to view for payment, or the advertisement has been manually removed from Active status for another reason).

The table also includes a field specifying the path and file name of the advertisement, thereby allowing the system provider 104 to dynamically access and serve the advertisement to the users 106.

The database also includes an advertisement profile table. Each record in the advertisement profile table specifies the profile of each advertisement, as identified by advertisement ID. In general, the profile is any information that identifies a target user audience (as broad or as focused as the advertiser 102 desires) for the advertisement. As such, in the present embodiment, the profile includes the following parameters: minimum age, maximum age, gender, marital status, nationality, profession, household income, race, state, and the like. Each record also includes an indication of the date the record was created and last modified.

As described below, the present embodiment preferably tracks user response to each advertisement by asking each user 106 to rank the overall experience of the advertisement. Consequently, the database includes an advertisement ranking table, which stores the average ranking provided for each advertisement. To this end, each record in the table includes the advertisement ID, the ranking (e.g., 1 (worst)-10 (best)), and the number of times the advertisement has been viewed and ranked.

As noted above, users 106 are provided with questions based on each advertisement and are provided with a monetary credit incentive to understand the advertisement. The user's understanding of each advertisement is measured by a series of questions. These questions are stored in the advertisement question table. For each advertisement, as identified by advertisement ID, the table includes a record for each question. More specifically, each record identifies the advertisement ID, a question ID, which uniquely identifies the question for that advertisement, the answer to the question (e.g., where the question is multiple choice, the letter or number of the correct answer, or where the question is fill in the blank, a character string of the correct answer), the question category, the actual question, and the different answer choices.

There are two categories of advertisement questions: Generic questions that test whether the user 106 actually paid attention to details of the advertisement (e.g. “What color was the car in the ad?”) and Brand questions that test whether the user 106 understood the brand message that the advertiser wanted to communicate (e.g., “Q: Chevy Trucks are “like a ______” A: 1)Stick 2)Stone 3)Rock”). Two questions will be randomly drawn from the Generic category, and one question will be randomly drawn from the Brand pool whenever a user is presented with the questions after the advertisement has run. Accordingly, it will be understood that several records in the advertisement question table will pertain to the same advertisement, each record relating to a different question. Furthermore, an advertiser 102 may provide multiple questions of each type so that different questions will follow the same advertisement after it is viewed. It should also be understood that although the present embodiment utilizes two categories of questions, alternate embodiments may utilize only one category or more than two categories. Furthermore, it is within the scope of the present invention to provide fewer or more than three advertisement questions after viewing of the advertisement, and such questions may be divided among the different categories of questions in any manner (e.g., out of three questions, two generic and one brand question or one generic and two brand questions, etc.).

Information concerning the incentive is stored in the advertisement value table. Each record corresponds to a different advertisement (as identified by advertisement ID) and stores the amount of the cash incentive provided to the user 106 when answering one question correctly, two questions correctly, three questions correctly, etc. In the present embodiment, there is extra incentive given for users to try to get all three questions correct via a scaling incentive system. For example, one correct question will pay $0.04, two correct will pay $0.10, and three correct will pay the full $0.65 incentive. These incentive levels will be specified and decided upon by the advertiser based on their brand goals, number of users they want to reach, and budget. In alternate embodiments, other incentive levels are provided, for example, earning an incentive only if all or a certain number of questions are answered correctly; earning the same amount of credit for each question answered correctly; deducting credits from a maximum credit for each question answered incorrectly; and the like.

The database also includes an advertisement survey questions table for storing the survey questions presented to users 106. As described in greater detail below, survey questions include top-line research questions that allow users 106 to rate the advertisement based on likeablility or other factors, and allow the users 106 to specify their level of purchase intent after watching the advertisement. Examples of other survey questions that may be asked prior to or after viewing of the advertisement include: Which of the following brands have you heard of? Have you ever purchased any of the following products? Of the following products, which one do you believe is the best quality? Best tasting? Best value? and the like. More specifically, each record in the table corresponds to a question, as identified by question ID, and includes question type, the actual question, and the answer choices.

The advertisement survey response table stores the users 106 responses to the survey questions. Accordingly, each record corresponds to a user (as identified by ID) and an advertisement (also as identified by ID) and stores the question ID and user response. Accordingly, each record in the table corresponds to a user, advertisement and question combination and stores the user response, the actual answer and the credits earned by the user 106. As such, the system provider 104 can provide the advertiser 102 with an indication of what points or themes were or were not effectively presented to users 106.

It is to be appreciated that the information collected is to be made available to the advertisers 102 so the advertisers 102 can better tailor advertising campaigns and better design individual advertisements. To this end, the database includes an advertisement question response table for storing the user responses to other than survey questions.

The database also tracks the amount of the user's credits and debits. To this end, the database includes a user credit table and user debit table. The user credit table includes one or more record for each user, as identified by user ID. More specifically, each record pertaining to a particular user corresponds to an advertisement for which the user earned a credit and stores the amount of the incentive received by a user after answering questions for that advertisement, and the date and time the user received the credit.

Similarly, the user debit table includes a record for each user, as identified by user ID, that has requested all or a portion of the user's credits be cashed out. As such, each record in the user debit table includes the user ID, the amount requested, the date of the transaction, the transaction number, and an indication as to when the record was created and last modified.

A user account table also tracks the credits and debits associated with each user. More specifically, the user account table includes a record for each user, as identified by user ID, and includes the following information: total user credits, total user debits, the user's monthly credit, the user's monthly debit, and an indication as to when the record was created and last modified.

Lastly, the database includes an advertisement sequence table for setting forth the sequence of the questions for each advertisement. More specifically, for each advertisement, the total number of questions in each pool (Generic and Brand) is tabulated, and a random number generator is used to select a questions from each pool. For example, if there are 30 questions in the Generic pool, the random number generator will select a number randomly between 1 and 30, and the corresponding question will be given to the user. The information on which questions a user 106 has seen is stored in the advertisement question response table, and if the user 106 elects to view the advertisement again and have another chance at answering questions, the user will see different questions from the ones previously asked to that user for a given advertisement. The order of the questions is also random although in alternate embodiments the questions may be stored an presented in a predetermined order.

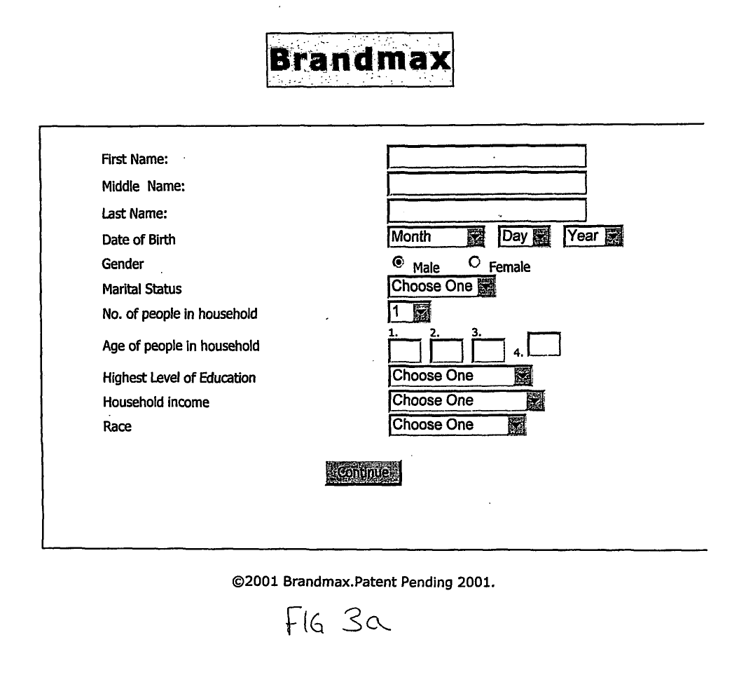

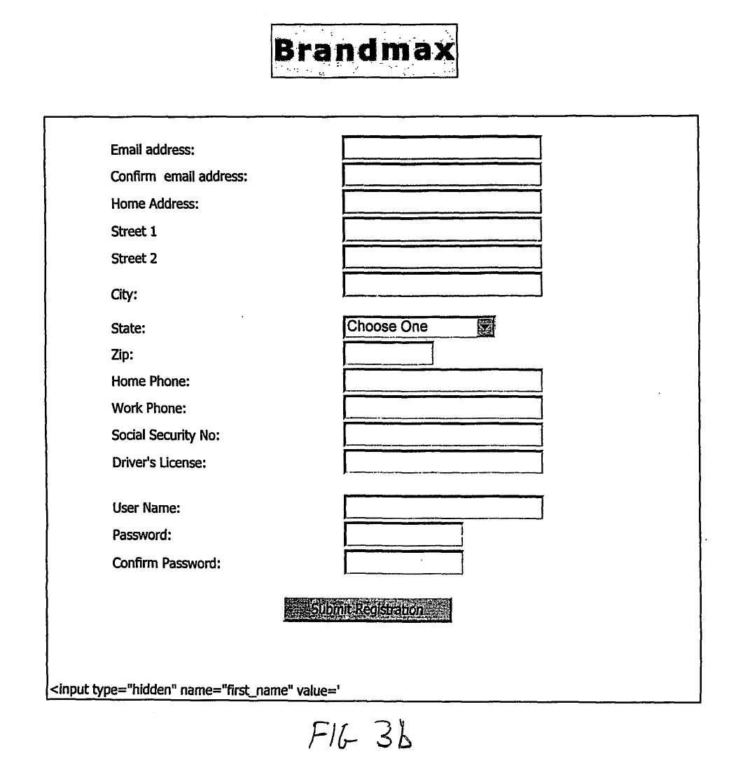

Having described the components of the present embodiment, its operation will now be described in greater detail with reference to FIGS. 2-18. It is to be understood that the functionality of the system described herein may be implemented in any of a number of ways, but is preferably provided via one or more software programs or components running on the system provider's computer system. Turning first to FIGS. 2-9, there is shown screens of a user interface provided via the system provider's system. In operation, the user first accesses the service provider's web site and is given the option to either register as a new user 106 or log in as an existing user by selecting the appropriate button. FIG. 2. Having selected the register now option, the user 106 is presented with the registration forms of FIGS. 3a and 3b. As illustrated, the registration form includes fields for collecting the information used to create the user's record in each of the user authorization table, user profile table and user details table. As also illustrated, many of the fields contain pull down menus for selecting one of multiple predefined answers. As part of the registration process, the system also assigns the user a user ID.

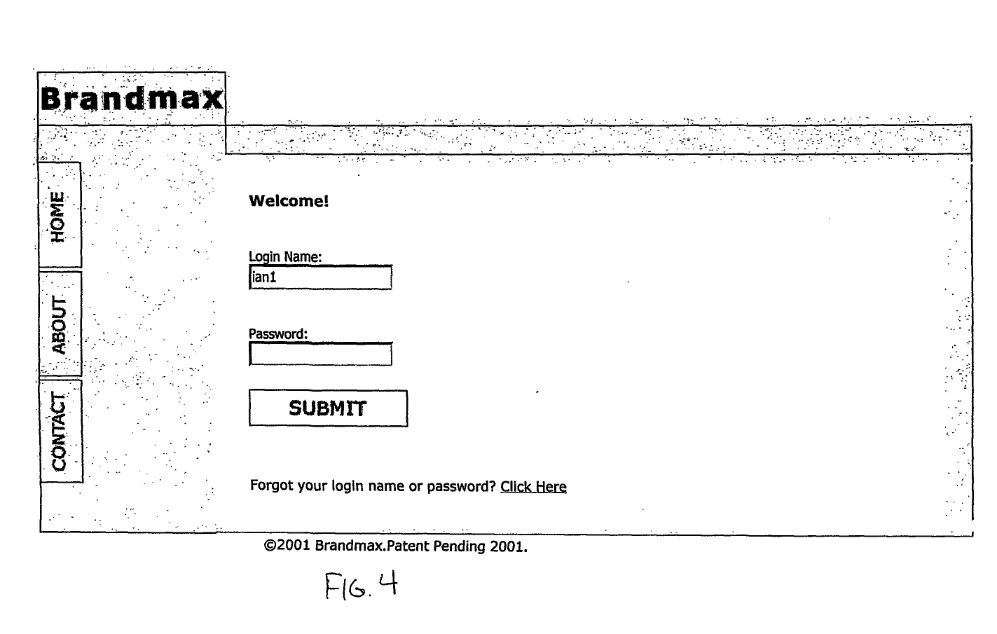

Users 106 who have already registered with the system, may select the log in option from the system provider's home page. When selecting the log in option, the user is presented with another page requesting that the user 106 enter its log in name and password. FIG. 4. As part of the login process, the system confirms the log in name and password exist in a record in the user authorization table, and the system confirms the status in that record indicates that the user 106 is enabled and verified.

Once the user 106 is logged in to the system, the user is presented with a page having the following information: an identification of the highest rated advertisements of those that the particular user 106 qualifies to view, the total pool or set of advertisements that are available for the user to view, their respective maximum incentive level offered, a selection of a high bandwidth or low bandwidth version of the advertisement, the media format, and the user's monthly and total credits. More specifically, the listing of the top ranked advertisements is dynamically generated based upon entries in the advertisement ranking table. It is to be understood that any number of advertisements may be displayed along with their rank, as well as any information specific to the listed advertisement contained within the database.

In the present embodiment, the ranking information is presented to each user 106 in an essentially customized fashion; each user 106 sees the ranking of only those advertisements that user 106 is able to view. The ranking is calculated by first identifying the set of advertisements that a particular user 106 can view for payment based on the user's profile, and ranking the advertisements by rating (from 0 to 10) given to the advertisements by other users 106 that have watched the advertisements (calculated by taking the aggregate of all ranking scores for a given advertisement divided by the number of users who have ranked the advertisement). For example, if there are a total of thirty advertisements that User A can watch for payment, the top ten of those thirty based on the average of other user's ratings of those advertisements will be shown in the “Top Rated Ads” box. A program or script running on the system accesses the advertisement ranking table to determine which advertisements out of the pool of advertisements the user 106 can watch for payment have the highest ranking.

When displaying the advertisements available for the user 106 to view, the system generates the list of advertisements by comparing the user's profile, as stored in the user profile table, to the advertisement profile, as stored in the advertisement profile table. From the universe of all advertisements whose profile meets the user's profile, only those advertisements having an Active status and sufficient remaining credits are displayed. As illustrated, the company, brand and maximum incentive is listed for each such advertisement although in alternate embodiments any information stored within the database may be displayed. Additionally, for each advertisement a hypertext link is provided to view the advertisement. Preferably, the system provides the user with multiple links, allowing the user to select the appropriate bandwidth, bit rate, media format, etc. suitable for viewing on the user's system.

Additionally, the user is presented with its account credit information. In the present embodiment, the user is presented with its current month total and aggregate total, both of which are stored and retrieved from the user account table.

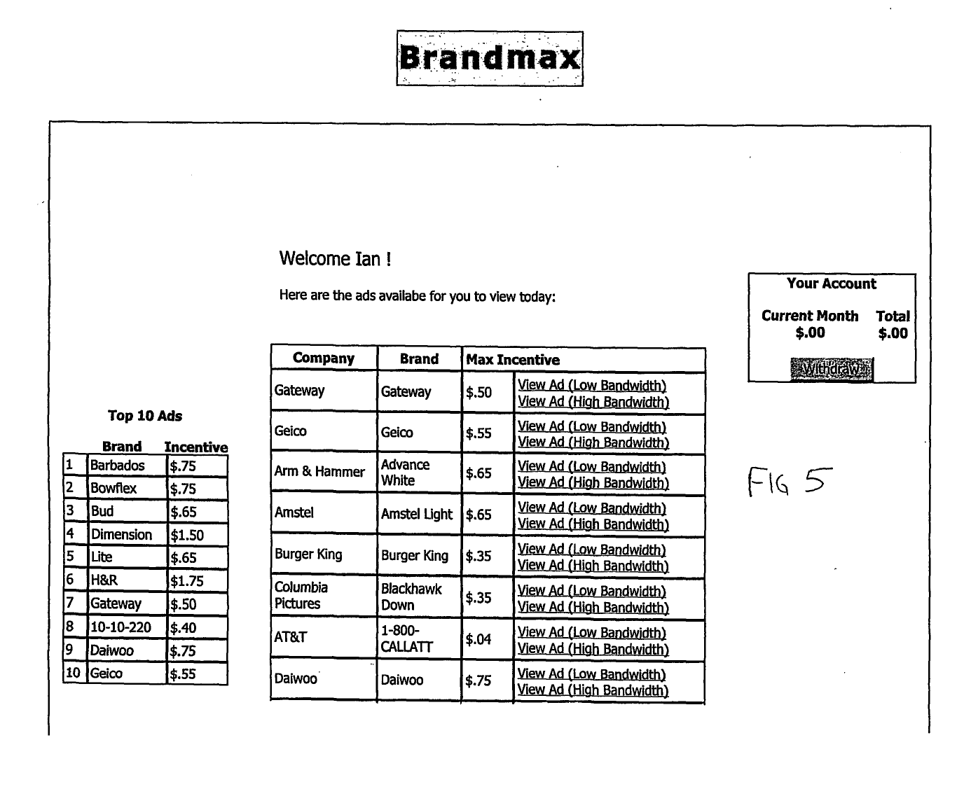

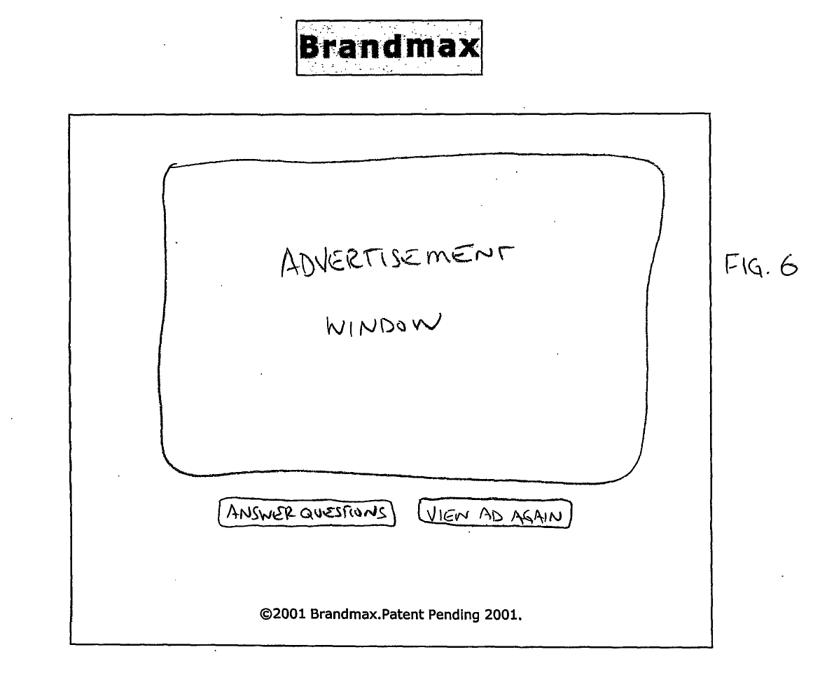

When the user 106 activates the link for viewing an advertisement, the system provides the user 106 with another page in which the advertisement is shown. It should be understood that the present invention covers all manners of displaying the advertisements to the users 106. In the present embodiment, the advertisements are streaming media served from the system provider's server; however, in alternate embodiments, the advertisement may be streamed from the advertiser's own server, in which case the file name field in the advertisement header table would point to the advertiser's server, as would the link on the user interface screen (e.g., FIG. 5). As illustrated in FIG. 6, once the advertisement is finished, the system presents the user 106 with two choices: the ability to answer questions concerning the advertisement and earn credits or view the advertisement again. When the user chooses to answers questions, by activating the “answer questions” button, the system presents the user with a question page.

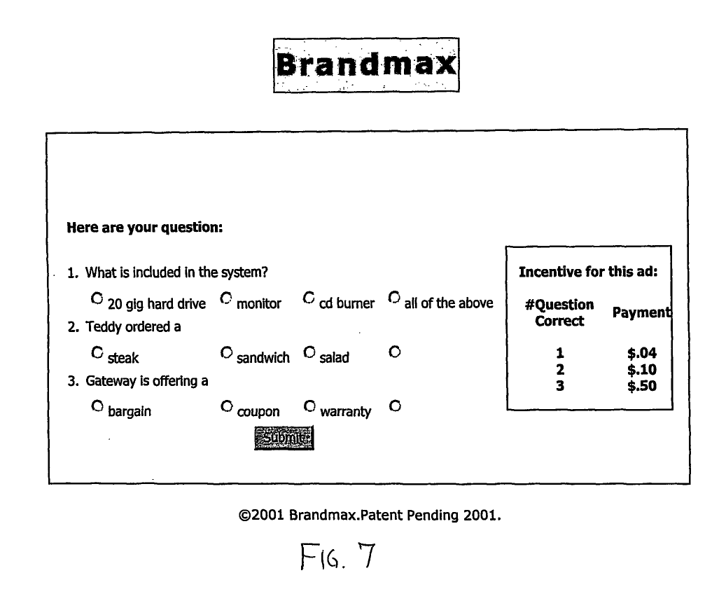

In the present embodiment, the questions page includes a series of questions concerning the advertisement (in the present embodiment three questions) as well as potential answers to the questions. FIG. 7. The system dynamically creates the page by retrieving the questions and potential answers from the advertisement question table described above. As illustrated, each potential answer is associated with a button or other means for the user 106 to select the answer.

The questions page also provides the user 106 with the incentives associated with the advertisement. In the present embodiment, the user 106 is provided with an ascending incentive for each question answered correctly; however, any incentive scale, or even different incentive scales for each advertisement, is within the scope of the present invention. The incentives for a particular advertisement are stored in and retrieved from the advertisement value table. Once the user 106 enters the questions and submits its response, the system presents the user 106 with another page.

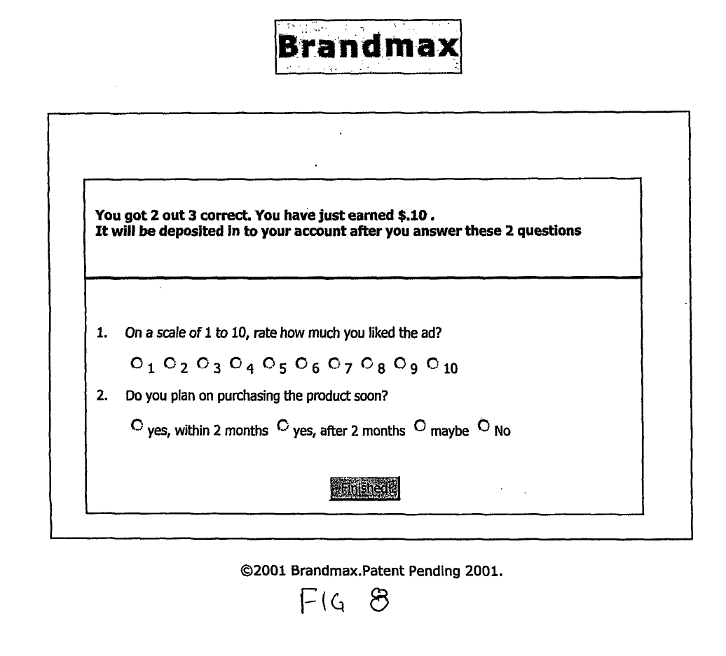

As illustrated in FIG. 8, the system presents the user with the results of answering the questions, namely how many questions the user answered correctly and the amount of incentive earned by the user 106. Additionally, in the present embodiment, the system requires the user 106 to answer one or more survey type questions.

Although the present embodiment presents both advertisement questions and survey questions to the user 106 after viewing of the advertisement, in alternate embodiments the system presents either or both categories of questions to the user 106 prior to viewing the advertisement. For example, questions may be presented to the user prior to viewing the ad to gauge brand awareness, purchase behavior, or other measures prior to exposure to the ad.

In determining the amount of incentive earned by the user 106, the system compares the user's answers with the actual answers as stored in the advertisement question table for the particular advertisement and question. Based on the number of questions answered correctly and the incentive scale stored in the advertisement value table, the system determines the amount of incentive earned.

Additionally, when the system receives the user's answers, the system creates entries in the advertisement question response table, thereby tracking the user's response.

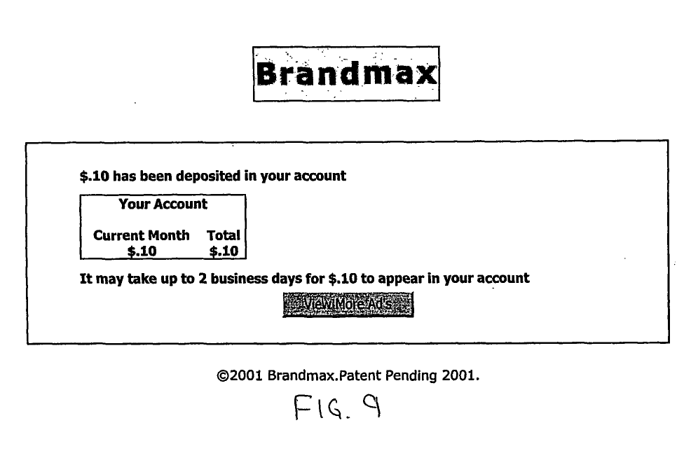

Once the user 106 answers the survey questions and submits its answers by activating the “finish” button, the system presents the user with another screen confirming that the earned credits have been deposited into the user's account. FIG. 9.

Such confirmation page provides the user with not only the earned credit, but also with the user's updated account balance information. As such, when the user 106 submits answers to the survey questions, the system updates the user's record in the user credit table, and user account table.

Additionally, when the user submits answers to the survey questions, those answers are noted in the advertisement survey response table and the advertisement ranking table.

The confirmation page also provides the user 106 with the ability to view additional ads to earn additional credits or to log out of the system. In the event the user 106 selects the option to view additional ads, the user 106 is presented with a modified version of the page shown in FIG. 5. More specifically, the system preferably removes from the list of available advertisements all advertisements that the user 106 viewed within a predetermined amount of time (e.g., the same day, week, fourteen day period, month, and the like). As such, advertisers 102 are assured that a single user 106 cannot repeatedly answer the same questions on the same ad thereby receiving multiple credits; instead, the credits provided by the advertiser 102 are spread across multiple users 106 in its targeted audience.

When a user's advertisement page is displayed, the system checks the user profile table and advertiser profile table to determine the set of advertisements that the user is allowed to view for payment by comparing the advertisement profile to the user's profile. Form this set of advertisements, the system excludes those advertisements identified as being previously viewed by the user 106 (as indicated by a record in the advertisement survey response table having the advertisement ID). The last date and time the user 106 viewed and answered questions concerning the advertisement is indicated in the advertisement survey response table in the field specifying the date and time the record was last modified. The difference between this date and time and the then current date and time is compared against a predefined time period (e.g., day, week, number of hours, number of days, and the like) to determine whether the user 106 can view the advertisement again.

As indicated in FIG. 5, each user 106 is also presented with the option of withdrawing credits from its account. To reduce administrative costs, however, the system preferably restricts each user 106 from withdrawing credits below a certain threshold. When a user 106 activates the “withdraw” button, the user is presented with another page asking the user to specify how many credits it wishes to withdraw and the manner in which the user 106 wishes to receive payment. In certain embodiments, the user is required to withdraw all of its funds and/or receive payment in a predetermined manner. As discussed below, a user's decision to withdraw credits causes a record to be created in the user debit table.

It should be understood that the order of steps in the foregoing embodiments may be altered and additional steps may be added while keeping with the present invention. In this regard, an alternate embodiment provides the user 106 with the option of accepting payment or not accepting payment and viewing the advertisement again. By way of example only, such options may be provided after displaying to the user the number of credits (e.g., dollars) earned based on his answers to the advertisement questions, but prior to presenting the survey questions. For example, if the user 106 received only partial credits, he could select the option of viewing the advertisement again in the hopes of receiving the highest level of credits. While the system provider 104 may give the advertisers 102 the option to enable or disable this feature (such indication being stored in an additional field in the database or as a flag associated with the advertisement), it is anticipated that advertisers 102 will enable such option as it essentially provides the advertiser 102 with multiple user exposures to the advertisement for the price (incentive credit) of one.

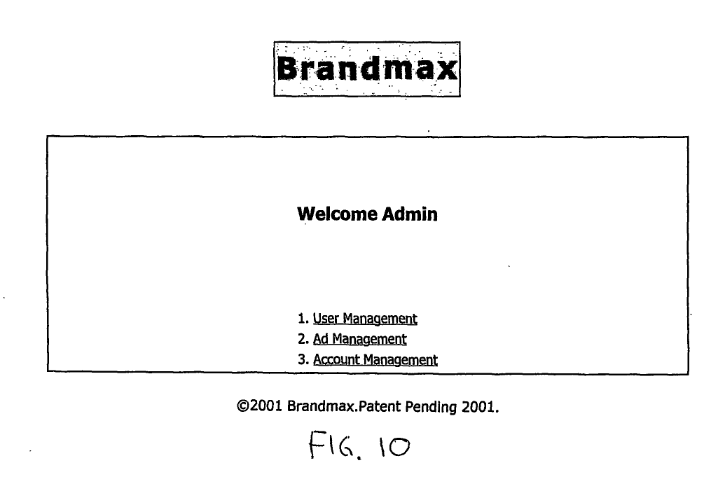

Having described the user's interaction with the system, the discussion will now focus on system administration. Although any number of administrative functions may be provided via an interface to the system provider's system (e.g., a secure web site, dedicated terminals coupled to the system, and the like), the present embodiment provides a secure web page for performing three categories of functions: (1) user management; (2) advertisement management; (3) account management. FIG. 10.

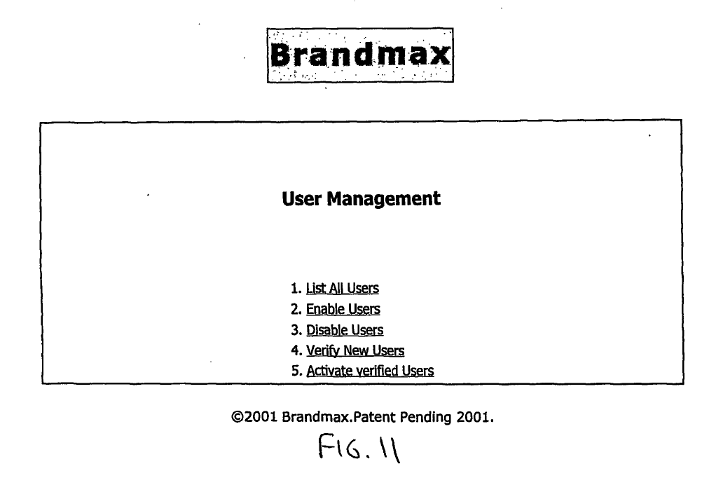

As illustrated in FIG. 11, user management entails five functions: (1) listing all users; (2) enabling users; (3) disabling users; (4) verifying new users; and (5) activating verified users. In general, the list of all users provides any of the information stored in the database for each user, including, for example, first name, last name, e-mail, address, and status.

Enabling users generally entails the administrator selecting from a list of users 106 those users 106 whose information is deemed to be “accurate”, e.g., there are no numbers in the Name field, there are 9 digits and 2 dashes in the Social Security number field, etc. The status field of those users 106 meeting the criteria for being “enabled” is updated to reflect as such. Additionally, users 106 can be manually disabled, i.e., locked out from the site if necessary (a mechanism to protect from suspected fraudulent users 106). In such an instance, the status field is updated to reflect the “disabled” status.

When the option to verify new users is selected, the system provides a list of all users who status is Enabled, as well as identifying information for each such user. Accordingly, the system administrator may then request the identity of such users 106 be verified, for example, by using third party verifiers such as Experian, Inc. As such, the system provider can assure advertisers 102 that the received demographic information is accurate and that the advertisers 102 are truly reaching their targeted audiences. Once the user is approved and verified, the system preferably provides the user with a notification e-mail confirming the user's approval.

Once the user is Enabled and then Verified, the user will be classified as “Enabled and Verified”, and granted access to the advertisements that they can view for payment.

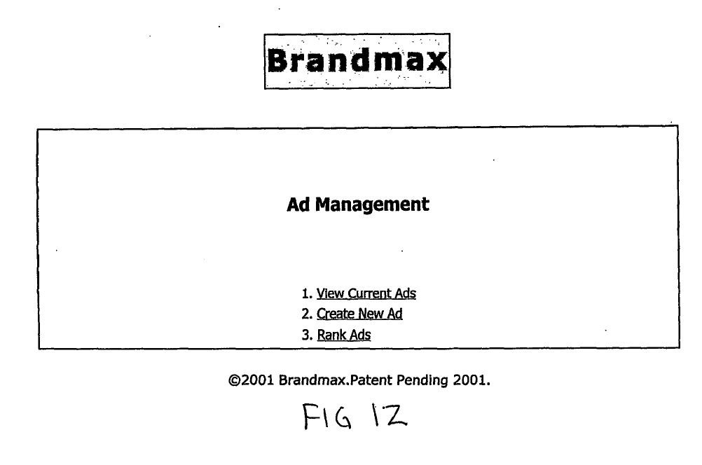

When the system administrator selects the advertisement management option (FIG. 10), the system presents the administrator with a page having links performing three functions: (1) view current ads; (2) create new ads; and (3) rank ads. FIG. 12.

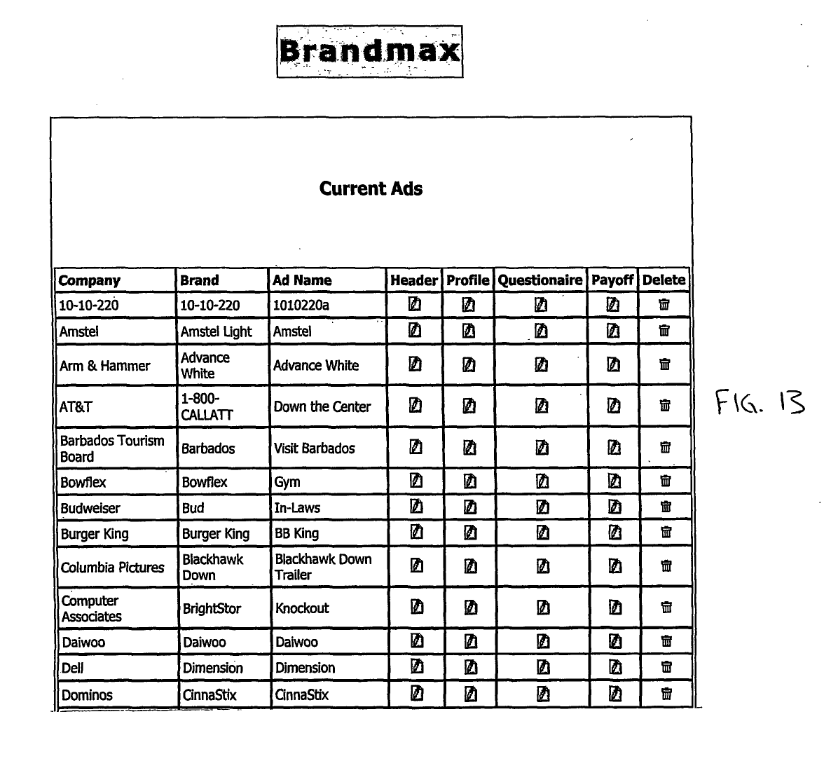

When viewing current ads (FIG. 13), the system may present the administrator with any information stored in the database. In the present embodiment, each advertisement is identified by company, brand and name of advertisement. Additionally, the administrator is presented with the option of viewing information stored in the advertisement header table and advertisement profile table and changing such information. Additionally, the administrator may view and edit the questions and incentive levels stored for the particular advertisement. Although the present embodiment envisions an administrator of the system provider 104 entering and editing the advertisement related information, it is within the scope of the present invention to permit each advertiser 102 to access its own account and advertisement information and update the same, for example, via a secure site. In certain of such embodiments, effectuation of the entry and changes to the information is subject to an administrator approval.

Furthermore, the administrator may view the amount of credits earned by users 106 viewing the particular advertisement (“payoff”). This information is stored in and retrieved from the user credit table. More specifically, the system searches the user credit table and sums the credit amount field for all records pertaining to the advertisement (as identified by ID in the record).

Lastly, the system provides the administrator with the option of deleting the advertisement. By selecting the “delete” option for a particular advertisement, the administrator causes the status of the advertisement, as stored in the advertisement header table, to be changed to Inactive, thereby preventing the advertisement from being presented to users 106. Alternatively, when the administrator selects the delete option, the system causes the end date field to be changed to the current date or the system simply deletes the entry for the advertisement altogether.

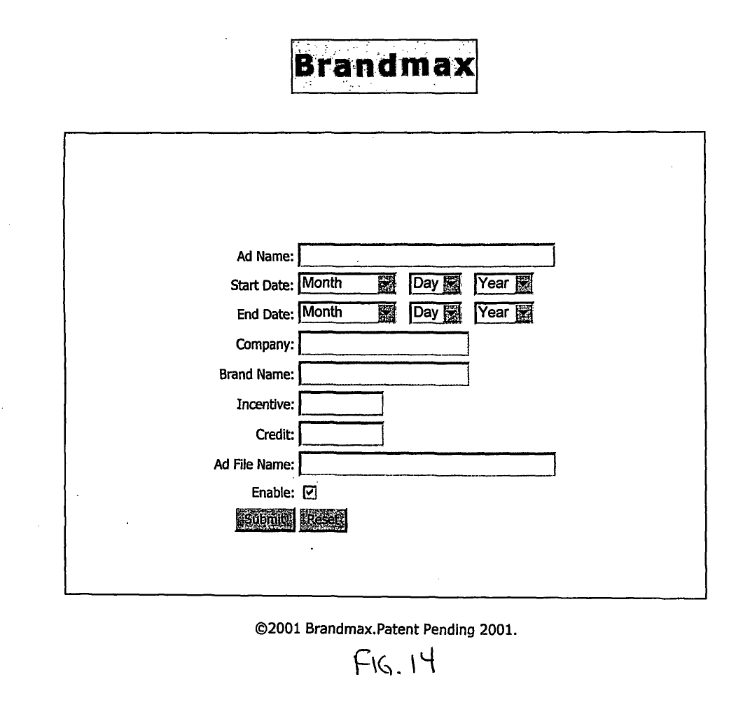

When the “create new ad” option is selected, the system presents the administrator with a data entry page for entering advertisement identifying information. FIG. 14. In addition to the identifying information, the page also includes an indication as to the status of the advertisement (i.e. whether or not the advertisement is Active and available for viewing by users 106). When the administrator submits the information entered, the system updates the advertisement header table by assigning an advertisement ID and creating a record. The administrator is then shown an “advertisement profile” input screen through which the administrator can enter the profile information for the advertisement (e.g., age, profession, etc). In short, the administrator enters all information necessary to populate the advertisement header, profile, question and value tables. In alternate embodiments, however, the advertiser 102 enters some or all of the information remotely.

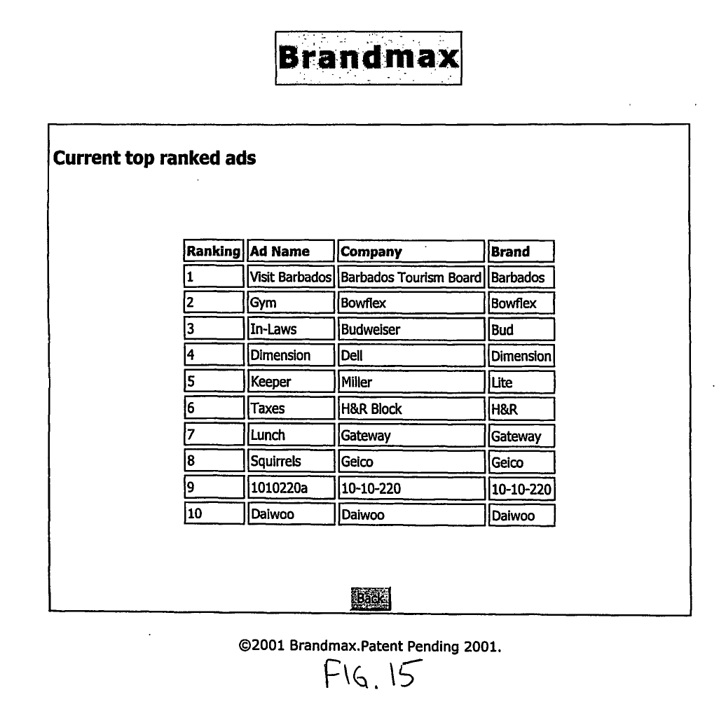

An exemplary page displayed in response to the administrator selecting the rank ads link is shown in FIG. 15.

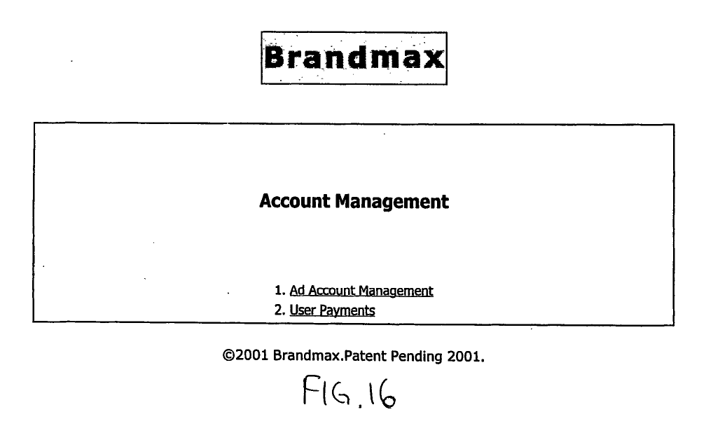

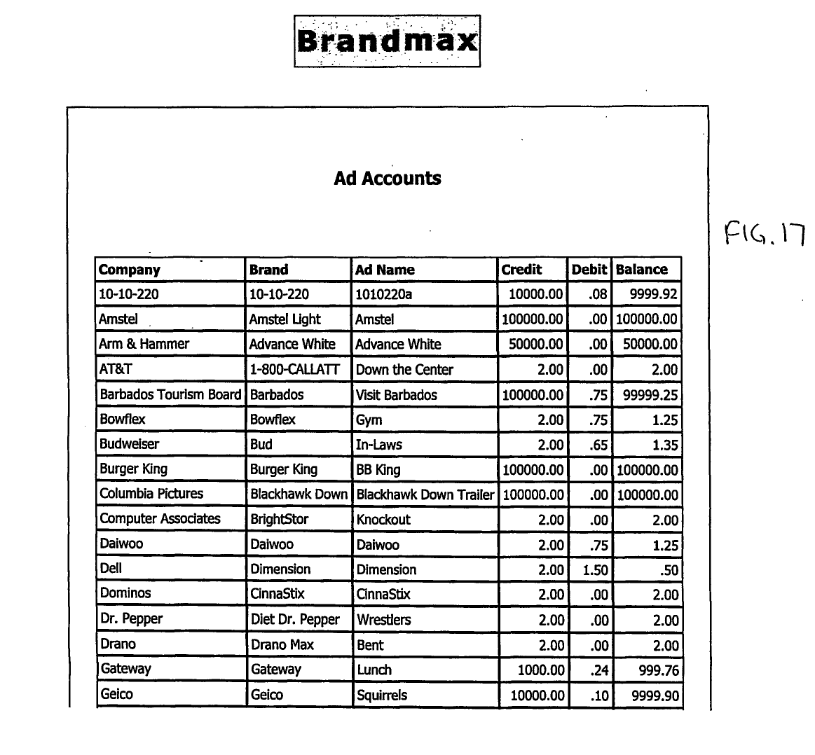

When the system administrator selects the account management option, the system presents the administrator with two further options: (1) advertisement account management; and (2) user payments. FIG. 16. When the advertisement account management option is selected, the system presents the user with the page of FIG. 17. As shown therein, each advertisement is listed, and is identified by any of a number of fields of information, including, for example, company, brand and advertisement name. Additionally, for each advertisement, the system displays the total credit provided by the advertiser 102 for the advertisement, as well as the total debit for the advertisement, both of which are stored in the advertisement header table. By subtracting the total debit from the total credit, the system is also able to display the remaining balance for the advertisement, and cross check the amount with the credit budget set by the advertiser.

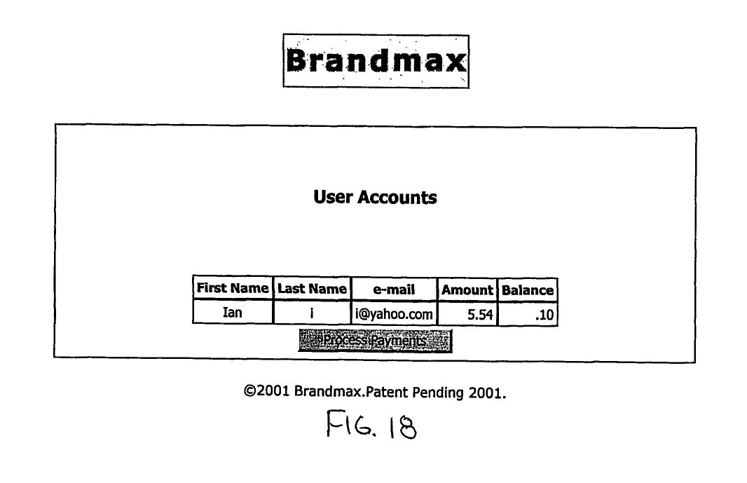

When the administrator selects the user accounts option, the system displays a list of users 106 that have requested a withdrawal of account credits. More specifically, the system access the user debit table and creates a display for each record stored therein. As illustrated in FIG. 18, the present embodiment displays the user's name, email address, as well as the amount being withdrawn and the remaining balance in the user's account, which is received from the user account table. The administrator is provided the option of processing the payments for the listed accounts by selecting the “process payments” button. By activating the button, the system automatically transmits the information in the database necessary to effectuate payment. For example, if there are one thousand users 106 who have more than the payment threshold amount in their account (e.g. $10), those one thousand users 106 will receive payment of their accumulated incentives. If payment is processed by a third party payment service (such as PayPal), an email is sent to the third party with each user's (third party) account details, and the third party then debits the system provider 104 account and credit's the user's account. In certain embodiments, the administrator is given the option to process selected ones of the user accounts.

While the foregoing embodiments have been described in the context of on-line delivery of and feedback on advertisements, alternate embodiments of the invention utilize other delivery and feedback mechanisms and processes. For example, in certain embodiments, the advertisement is delivered via traditional off-line channels, such as print, radio, and out-of-home advertising in order to help advertisers break through the clutter and help grab the attention of their consumers. In such embodiments, the system provider 104 could present its logo or other indicia in connection with an advertisement, indicating to viewers/listeners/readers (user 106) that there is an opportunity to receive incentive credits based on the advertisement. The user 106 would access the system provider's website and answer questions as in any of the foregoing embodiments. By way of example, the system provider's logo may be placed on a Ford print advertisement running in Sports Illustrated magazine, which would create an environment where the reader would pay more attention to the print advertisement because the reader knows he can access his account later and get paid for answering a few questions about the advertisement to prove that they read and understood it.

In addition, the system may be used to conduct robust copy-testing research for advertisers. For example, a number of core users in an advertiser's target demographic can be invited to participate in (online) research prior to the national launch of a new television advertisement. The users will be paid a sum (e.g., some amount greater than that typically provided for answering the questions associated with a currently running advertisement, such as $15) for answering relatively more probing questions and/or a greater number of questions (e.g., a greater number of questions, such as forty) about a given advertisement. Also, advertisers may be able to use the system to interact with users in a certain profile demographic and having the users view different versions of an advertisement or different advertisements directed to the same product and “vote” for their favorite one. The votes could be tallied similar to the rankings discussed above to determine the advertisement(s) having the highest average rating. The favorite(s) could then be considered for a national campaign (e.g., television, print, radio, etc.).

Those skilled in the art will recognize that the method and system of the present invention has many applications, may be implemented in many manners and, as such, is not limited to the foregoing exemplary embodiments and examples. Moreover, the scope of the present invention covers conventionally known and future develop the variations and modifications to the system components and processes described herein as would be understood by those skilled in the art.

1. A method for providing interactive advertising, the method comprising:
presenting an advertisement to a user;
presenting questions to the user, the questions related to the advertisement;
providing an amount of credits to the user, the amount based on a number of the questions answered correctly by the user.

2. The method of claim 1 wherein the amount increases on an ascending scale as the number of questions answered correctly increases.

3. The method of claim 1 wherein the credits is money.

4. The method of claim 1 wherein the questions include generic questions.

5. The method of claim 1 wherein the questions include brand questions.

6. The method of claim 1 wherein the questions include survey questions.

7. The method of claim 1 wherein presenting the advertisement includes transmitting the advertisement over a network.

8. The method of claim 1 wherein the advertisement has an advertisement profile and the user has a user profile, the advertisement being presented to the user based, at least in part, on the user profile matching the advertisement profile.

9. The method of claim 1 wherein each advertisement has an advertisement profile and the user has a user profile, and the one or more advertisements are selected based on correspondence between the advertisement profiles and the user profile and wherein the advertisement presented to the user is selected by the user.

10. The method of claim 9 wherein the questions include both at least one general question and at least one brand question.

11. The method of claim 10 wherein providing the credit to the user is performed after receiving user response to at least one survey question.

12. The method of claim 1 wherein an advertiser provides the advertisement, the method further comprising receiving answers to the questions and providing information related to the answers to the advertiser.

13. The method of claim 1 further comprising receiving a rating for the advertisement.

14. The method of providing interactive advertising, the method comprising:
identifying groups of advertisements to a plurality of users, wherein each advertisement has an advertisement profile and each user has a user profile, and each group is presented to each user based on a correspondence between advertisement profile and user profile;
receiving an indication of a selected advertisement from each user, the selected advertisement being one of the groups identified to the user;
presenting each user's selected advertisement to that user;
receiving from each user an answer to one or more questions concerning the advertisement selected by that user;
providing each one or more users with an incentive based on answers received from each of the one or more users that are correct; and
compiling information based on the answers to questions and making such information available to advertisers.

15. A system for providing advertisements to user, the system comprising:
a computer configured to:
select one or more advertisements from a group of advertisements for identification to a user;
present to the user an advertisement from the one or more advertisements;
provide one or more questions to the user based on the advertisements; and
provide the user with a level of credits based on correct answers to the questions.

16. The system of claim 15 wherein the level increases on an ascending scale as the questions answered correctly increases.

17. The system of claim 15 wherein the credits is money.

18. The system of claim 15 wherein the questions include generic and brand questions.

19. The system of claim 18 wherein the questions include survey questions.

20. The system of claim 15 wherein each advertisement has an advertisement profile and the user has a user profile, and the computer is configured to select the one or more advertisements based on comparison of the advertisement profiles with the user profile.
